(19) United States
(12) Patent Application Publication
(10) Pub. No.: US 2017/0261101 A1
(43) Pub. Date: Sep. 14, 2017

(54) Device Reducing Drag Loss in an Automatic Transmission

(71) Applicant: ZF Friedrichshafen AG, Friedrichshafen (DE)

(72) Inventors: Markus Herrmann, Scheidegg (DE); Thilo Schmidt, Meckenbeuren (DE); Gerhard Martin, Langenargen (DE); Ahmed Mouhcine, Friedrichshafen (DE); Rainer Grundler, Bodman-Ludwigshafen (DE); Dirk Winkler, Kressbronn (DE); Valentine Vincent, Friedrichshafen (DE)

(21) Appl. No.: 15/199,076

(22) Filed: Jun. 30, 2016

(30) Foreign Application Priority Data
Mar. 8, 2016 (DE) 10 2016 203 775.7

(51) Int. Cl. F16H 61/48; F16H 61/14; F16H 45/02; F16H 57/04

(52) U.S. Cl. CPC F16H 61/48; F16H 57/0412; F16H 57/0446; F16H 61/14; F16H 45/02

(57) ABSTRACT

A drag torque reduction device for an automatic transmission includes a hydraulic controller with a parallel connection of a pressure relief valve, a constant aperture and a temperature-dependent, switchable aperture that is positioned upstream of a radiator relative to a flow of fluid to the radiator. The parallel connection is disposed between a first control edge of a converter switching valve and a first line. The first line leads to both to the radiator and through a check valve to the converter ring. The first control edge of the converter switching valve is open and lubricating oil flows through the parallel connection when the converter switching valve is in a first switching position. The first control edge of the converter switching valve is closed and lubricating oil does not flow through the parallel connection when the converter switching valve is in a second switching position.

### FIELD OF THE INVENTION

The invention relates generally to a device for reducing the drag torque in an automatic transmission.

### BACKGROUND

The lubrication of transmission components and the cooling of components, in particular the shift elements of automatic transmissions of motor vehicles, is typically controlled in a manner dependent on torque and rotational speed, in order to provide the quantity of oil for lubricating and cooling transmission components that is in line with demand as much as possible. Due to the viscous properties of cooling oil, lower volume flows arise at low temperatures than at high temperatures, such that the quantity of oil supplied depends on temperature.

Strict fuel economy and emissions standards have resulted in the need to even further optimize the efficiency of automatic transmissions. Thereby, drag torque in particular is to be reduced in the range relevant for the consumption cycle. The NEDC (New European Driving Cycle) consumption cycle takes place in a limited range of operation, namely in the lower temperature range with moderate transmission loads.

DE 43 42 961 C1 discloses an arrangement for controlling the temperature of a hydraulic operating medium (working oil) for an automatically shifting transmission and a hydrodynamic torque converter with a converter feed line for the operating medium, for which a radiator for the heat dissipation of the operating medium with a radiator return line leading to the transmission and a control valve working as a function of the temperature of the operating medium are used, and a converter return line outgoing from the torque converter, a radiator supply line leading to the radiator and line for the control valve directly connected to the transmission are attached, whereas, at temperatures lower than a lower-temperature phase comprising a threshold value, it is both the case that the converter return line is shut off with respect to the radiator supply line and the line directly connected to the transmission is connected to a first of the lines attached to the control valve, while, at temperatures higher than an upper-temperature phase comprising the threshold value, it is both the case that the converter return line is connected to the radiator supply line and the line directly connected to the transmission is connected to a second of the lines attached to the control valve. It is thereby provided that the converter supply line is also connected to the control valve, that, in the lower-temperature phase, it is both the case that the converter return line is connected to the converter supply line and the line directly connected to the transmission is connected to the radiator supply line, and that, in the upper-temperature phase, the converter supply line is connected to the line directly connected to the transmission, such that a temperature-dependent radiator flow control is realized.

US 2014/0251745 A1 discloses a valve assembly for controlling the flow of oil through a radiator in a lubricating oil circuit of an electro-hydraulic transmission control unit, for which the radiator is connected to the lubrication oil supply through a parallel connection of at least two constant apertures and a hydraulically controllable switching valve, whereas, viewed in the direction of flow, a pressure relief valve is provided directly in front of such parallel connection. This switching valve may be hydraulically actuated by a solenoid with a control pressure in such a manner that an oil flow flowing through the switching valve to the radiator can be shut off, such that, at a low transmission load, the oil flow effectively flowing through the radiator for transmission lubrication is reduced to a predefined minimum amount.

### SUMMARY OF THE INVENTION

Exemplary aspects of the present invention provide a device for reducing the drag torque in an automatic transmission comprising multi-disk shift elements, a hydrodynamic torque converter and a converter clutch, which are controlled by a hydraulic controller with a radiator, which enables a reduction of the drag torque by reducing the quantity of cooling and lubricating oil and makes it possible to suspend the reduction of the quantity of cooling and lubricating oil when needed.

Accordingly, a device for reducing the drag torque in an automatic transmission comprising multi-disk shift elements, a hydrodynamic converter and a converter clutch, which are controlled by a hydraulic controller with a radiator and a converter switching valve connected through lines to a converter ring of the hydrodynamic converter, is proposed, which, in the hydraulic controller of the transmission in front of the radiator, features a parallel connection of a pressure relief valve in the direction of flow to the radiator that opens against a spring force above a pressure threshold, a constant aperture securing a minimum flow and a temperature-dependent, switchable aperture opening above a temperature threshold. In this manner, minimum lubrication and cooling are ensured at low temperatures and low system pressures, whereas, at high temperatures and/or pressures, the achievable reduction in the quantity of cooling and lubricating oil is suspended.

This parallel connection of the pressure relief valve, the constant aperture and the temperature-dependent, switchable aperture in the direction of flow to the radiator is arranged between a first control edge of the converter switching valve and a first line, which leads both to the radiator and through a check valve to the converter ring. Only if the converter switching valve is located in its first switching position, which is adjusted with a pressurized converter clutch, does the first control edge of the converter switching valve advance lubrication pressure and supply the parallel connection of the pressure relief valve, the constant aperture and the temperature-dependent, switchable aperture with lubricating oil, whereas, if the converter switching valve is located in its second switching position, which is adjusted with an open converter clutch, the first control edge of the converter switching valve is closed and lubricating oil does not flow through the parallel connection of the pressure relief valve, the constant aperture and the temperature-dependent, switchable aperture.

It may thereby be provided that, if the converter switching valve is located in a second switching position, the oil advancing to the radiator starting from a second control edge of the converter switching valve through a converter ring inlet into the converter ring and from the converter ring through a converter ring outlet back to a third control edge of the converter switching valve then continues to the radiator within the converter switching valve at a fourth control edge of the converter switching valve and from there through a second line, which is connected both to the fourth control edge of the converter switching valve and to the check valve leading to the converter ring, whereas, if the converter switching valve is located in a second switching position, the oil flow to the converter ring through the check valve is shut off, due to a pressure difference between the converter ring inlet and the second line.

Through the design in accordance with exemplary aspects of the invention, in the lower temperature range with moderate transmission loads (i.e., in the NEDC consumption cycle), the oiling quantities of the multi-disks of the shift elements is reduced, which, in an advantageous manner, results in a reduction in the drag torques caused by the shift elements.

In an additional exemplary form of the invention, it is proposed that the pressure relief valve is formed as a plate valve, on the return surface of which no pressure acts, in such a manner that the pressure in the opening direction of the plate valve is not the differential pressure between the two sides of the plate valve, but is only the pressure on the side of the plate valve turned away from the radiator. For this purpose, it may be provided that, at a pressure that exceeds a predetermined pressure threshold, the pressure relief valve is opened and enables the flow of oil through a third line to the radiator, whereas, at pressures that exceed an additional predetermined threshold value, which is higher than the predetermined pressure threshold, the spring of the pressure relief valve is compressed so far that a part of the volume flow flows in the direction of the oil sump.

### BRIEF DESCRIPTION OF THE DRAWINGS

In the following, the invention is more specifically illustrated as an example on the basis of the attached figures. The following is shown:

FIG. 1: A system pressure/oil temperature diagram to illustrate the areas of minimum lubrication and cooling; and

FIG. 2: A schematic presentation of an exemplary embodiment of the invention.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

Hydraulic controllers for automatic transmissions comprising a hydrodynamic converter and a converter clutch are well-known to the specialist, such that, within the framework of the following description of figures, only the components relevant to the invention are described and explained.

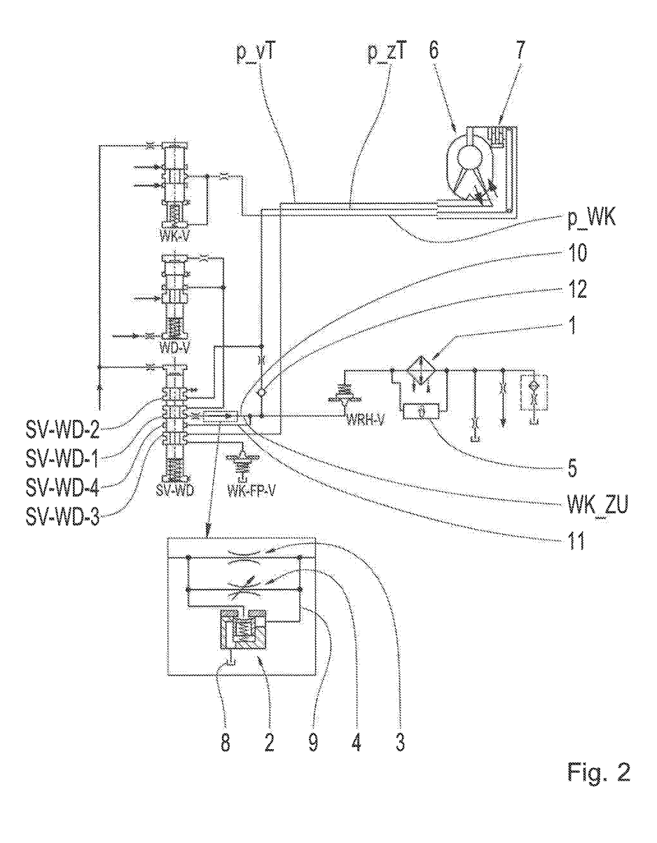

FIG. 2 shows a hydraulic controller for an automatic transmission comprising a hydrodynamic converter 6 and a converter clutch 7. The embodiments shown differ with respect to the varying arrangements and designs of the device in accordance with exemplary aspects of the invention. A converter clutch valve is designated with WK-V, a converter pressure valve is designated with WD-V, a converter switching valve is designated with SV-WD, a converter base point valve is designated with WK-FP-V and a converter retaining valve is designated with WRH-V. Furthermore, a radiator is shown with 1 and a radiator bypass is shown with 5; it is ensured through these that the oil is not directed through the radiator 1 at low temperatures. Thereby, the converter ring inlet pressure is designated with p_zT, the converter ring outlet pressure is designated with p_vT and the converter clutch pressure is designated with p_WK.

To reduce the drag torque in the automatic transmission comprising the hydrodynamic converter 6 and the converter clutch 7, a device is proposed, which, in the hydraulic controller of the transmission in front of the radiator 1, features a parallel connection of a pressure relief valve 2 in the direction of flow to the radiator 1 that opens against a spring force, a constant aperture 3 securing a minimum flow of oil and a temperature-dependent, switchable aperture 4 opening above a temperature threshold θ_sp. The pressure relief valve 2 may be designed, for example, as a plate valve.

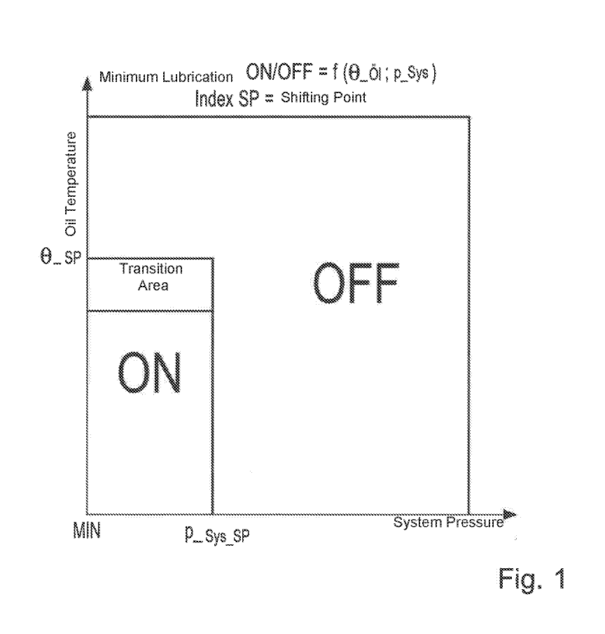

Through this arrangement, a minimum lubrication and cooling at low temperatures and low system pressures is ensured, since, at low temperatures that fall below a predetermined temperature threshold θ_sp, the temperature-dependent, switchable aperture 4 is closed, and, at low pressures that fall below a predetermined pressure p_Sys_SP, the pressure relief valve 2 remains closed. This is illustrated with reference to FIG. 1.

It is thereby clear that, at temperatures up to a maximum of θ_sP and pressures up to a maximum of p_Sys_SP, the minimum lubrication and cooling is provided through the constant aperture 3. At temperatures that exceed θ_sp, the volume flow increases. Furthermore, at a system pressure that exceeds p_Sys_SP, the oil flow increases, in order to not cause any damages to the transmission components at high transmission loads and low oil temperatures, and in order to ensure a sufficient oil supply of the shift elements for shifting. Preferably, the temperature-dependent, switchable aperture 4 and the pressure-limiting valve 2 are designed in such a manner that, with an open temperature-dependent, switchable aperture 4 or with an open pressure relief valve 2, the volume flow to the radiator 1 corresponds to the normal level corresponding to the current system pressure.

With the exemplary embodiment shown in FIG. 2, the parallel connection of the pressure relief valve 2, the constant aperture 3 and the temperature-dependent, switchable aperture 4 in the direction of flow to the radiator 1 is arranged between a first control edge SV-WD-1 of the converter switching valve SV-WD and a first line 10 which on the one hand leads to the radiator 1, and on the other hand leads through a check valve 14 to the converter ring. Only if the converter switching valve SV-WD is located in its first switching position, which is adjusted in WK-closed-operation with a pressurized converter clutch 7, does the first control edge SV-WD-1 of the converter switching valve SV-WD advance lubricating pressure, such that, with a closed converter clutch 7, the desired reduction of the lubricating and cooling oil flow is ensured.

In all other respects, through a targeted increase in the pressure to a pressure level above the predetermined pressure threshold p_Sys_SP, the pressure relief valve 2 may be opened depending on the situation, such that the reduction of the lubricating and cooling oil quantity is terminated depending on the situation.

If the converter switching valve SV-WD is located in its second switching position, which is adjusted in WK-open-operation with an open converter clutch 7, the first control edge SV-WD-1 of the converter switching valve SV-WD is closed, by which oil no longer flows through the parallel connection of the pressure relief valve 2, the constant aperture 3 and the temperature-dependent, switchable aperture 4. The oil supply to the radiator 1 now advances from a second control edge SV-WD-2 of the converter switching valve SV-WD initially (with pressure p_zT) into the converter ring, then through the converter ring outlet (with pressure p_vT) back to a third control edge SV-WD-3 of the converter switching valve SV-WD, from there within the converter switching valve SV-WD to a fourth control edge SV-WD-4 of the converter switching valve SV-WD connected to a second line 11. Such second line 11 is indeed connected to the check valve 12 leading to the converter ring; however, based on the pressure difference between the converter ring inlet pressure p_zT and the pressure in the second line 11, this check valve 12 is now located in its locked position, such that, in WK-open-operation, with which the converter switching valve SV-WD is in its second switching position, the oil flow from the second line 11 to the converter ring is shut off and the second line 11 only supplies lubricating oil to the radiator 1. As a result, with an open converter clutch 7, the radiator flow is not reduced by the parallel connection of the pressure relief valve 2, the constant aperture 3 and the temperature-dependent, switchable aperture 4.

In the exemplary embodiment shown in FIG. 2, the converter retaining valve WRH-V is arranged in the direction of flow to the radiator 1 between the line 10 and the radiator 1, such that the parallel connection of the pressure relief valve 2, the constant aperture 3 and the temperature-dependent, switchable aperture 4 in the direction of flow to the radiator 1 is arranged in the front of the converter retaining valve WRH-V.

As a structural configuration, in the exemplary embodiment shown in FIG. 2, the pressure relief valve 2 is formed as a plate valve, on the return surface of which no pressure—such as that caused by the radiator resistance—acts. For this purpose, it is provided that the pressure in the opening direction of the pressure relief valve 2 is not the differential pressure between the two sides of the pressure relief valve 2, but is only the pressure on the side of the pressure relief valve 2 turned away from the radiator 1, which, in an advantageous manner, effects a defined, precise opening pressure in the line to the radiator 1.

With the shown pressure relief valve 2, at a pressure that exceeds the predetermined pressure threshold p_Sys_SP, the pressure control valve 2 is opened and enables the flow of oil through a third line 9 to the radiator 1; at pressures that exceed an additional predetermined threshold value that is higher than the pressure threshold p_Sys_SP, the spring of the pressure relief valve 2 is compressed so far that a part of the volume flow flows in the direction of the oil sump 8, by which the system is advantageously protected against pressure peaks.

Modifications and variations can be made to the embodiments illustrated or described herein without departing from the scope and spirit of the invention as set forth in the appended claims.

### REFERENCE SIGNS

1 Radiator
2 Pressure relief valve
3 Constant aperture
4 Temperature-dependent, switchable aperture
5 Radiator bypass
6 Converter
7 Converter clutch
8 Oil sump
9 Third line
10 First line
11 Second line
12 Check valve
p_Sys System pressure
p_Sys_SP Pressure threshold
p_vT Converter ring outlet pressure
p_zT Converter ring inlet pressure
θ_ÖI Oil temperature
θ_SP Temperature threshold
SV-WD Converter switching valve
SV-WD-1 First control edge of the converter switching valve
SV-WD-2 Second control edge of the converter switching valve
SV-WD-3 Third control edge of the converter switching valve
SV-WD-4 Fourth control edge of the converter switching valve
WD-V Converter pressure valve
WRH-V Converter retaining valve
WK-FP-V Converter base point valve
WK-V Converter clutch valve

1-6. (canceled)

7. A drag torque reduction device for an automatic transmission, comprising:
a plurality of multi-disk shift elements;
a hydrodynamic converter;
a converter clutch;
a converter switching valve connected to a converter ring of the hydrodynamic converter; and
a hydraulic controller with a radiator, the hydraulic controller operable to control the plurality of multi-disk shift elements, the hydrodynamic torque converter and the converter clutch, the hydraulic controller comprising a parallel connection of a pressure relief valve, a constant aperture and a temperature-dependent, switchable aperture, the parallel connection positioned upstream of the radiator relative to a flow of fluid to the radiator, the pressure relief valve configured to open against a spring force above a pressure threshold, the constant aperture configured to permit a minimum flow through the parallel connection to the radiator, the temperature-dependent, switchable aperture configured to open above a temperature threshold, the parallel connection providing a minimum lubrication and cooling at low temperatures and low system pressures by closing the temperature-dependent, switchable aperture at temperatures below the temperature threshold and closing the pressure relief valve at pressures below the pressure threshold
wherein the parallel connection is disposed between a first control edge of the converter switching valve and a first line, the first line leading to both to the radiator and through a check valve to the converter ring,
wherein the first control edge of the converter switching valve is open and lubricating oil flows through the parallel connection when the converter switching valve is in a first switching position, the converter switching valve adjusted to the first switching position when the converter clutch is pressurized,
wherein the first control edge of the converter switching valve is closed and lubricating oil does not flow through the parallel connection when the converter switching valve is in a second switching position, the converter switching valve adjusted to the second switching position when the converter clutch is open.

8. The drag torque reduction device of claim 7, wherein:
when the converter switching valve is in the second switching position, the lubricating oil flows to the radiator starting from a second control edge of the converter switching valve through a converter ring inlet into the converter ring and from the converter ring through a converter ring outlet back to a third control edge of the converter switching valve then continues to the radiator within the converter switching valve at a fourth control edge of the converter switching valve and then through a second line connected both to the fourth control edge of the converter switching valve and to the check valve to the converter ring,
when the converter switching valve is in the second switching position, the lubricating oil does not flow to the converter ring through the check valve due to a pressure difference between the converter ring inlet and the second line.

9. The drag torque reduction device of claim 7, wherein the pressure relief valve opens when a targeted pressure increase to a pressure level above the predetermined pressure threshold is provided to the pressure relief valve such that a reduced flow of the lubricating oil is terminable.

10. The drag torque reduction device of claim 7, wherein the temperature-dependent, switchable aperture and the pressure relief valve are configured such that a volume flow to the radiator corresponds to a normal current system pressure level when the temperature-dependent, switchable aperture is open or the pressure relief valve is open.

11. The drag torque reduction device of claim 7, wherein the pressure relief valve is a plate valve, the plate valve having a return surface that is not exposed to an actuating pressure of the plate valve, the plate valve configured such that the actuating pressure in an opening direction of the plate valve is a pressure at a side of the plate valve turned away from the radiator.

12. The drag torque reduction device of claim 11, wherein the pressure relief valve opens and enables the flow of oil through a third line to the radiator at a pressure above the pressure threshold, a spring of the pressure relief valve is compressed such that a portion of a volume flow to the radiator flows towards of an oil sump at another pressure that exceeds an additional pressure threshold, the additional pressure threshold being greater than the pressure threshold.
